(19) United States
(12) Patent Application Publication
(10) Pub. No.: US 2026/0029309 A1
(43) Pub. Date: Jan. 29, 2026

(54) CLAMP MONITORING SYSTEMS AND METHODS FOR ERROR PROOFING HOSE CLAMP INSTALLATION

(71) Applicant: GM GLOBAL TECHNOLOGY OPERATIONS LLC, Detroit, MI (US)

(72) Inventor: Peter E. Petersen, VI, Royal Oak, MI (US)

(73) Assignee: GM GLOBAL TECHNOLOGY OPERATIONS LLC, Detroit, MI (US)

(21) Appl. No.: 18/785,504

(22) Filed: Jul. 26, 2024

(51) Int. Cl. G01M 99/00; G06Q 10/0631

(52) U.S. Cl. CPC G01M 99/00; G06Q 10/063114; F16L 2201/10

(57) ABSTRACT

A method of operating a clamp monitoring system includes a system controller receiving confirmation that a work part entered a test envelope within a workstation. Responsive to receiving this confirmation, the controller outputs command prompts to: (1) position a continuity testing device at a target clamp location at which a hose clamp attaches a hose to a hose connector of the work part, and (2) activate the testing device after being positioned at the target clamp location. The testing device transmits continuity data indicative of the hose clamp's electrical continuity to the controller. A position sensing device transmits position data indicative of the testing device's real-time position to the controller. The controller outputs a notification that the hose clamp is properly installed on the work part responsive to the continuity status indicating electrical continuity at the hose clamp and the real-time device position aligning with the target clamp location.

### INTRODUCTION

The present disclosure relates generally to fastening devices for motor vehicles. More specifically, aspects of this disclosure relate to systems and methods for confirming the proper installation of hose clamps during the assembly of automobiles.

Current production motor vehicles, such as the modern-day automobile, are assembled using a variety of different fastening devices, such as bolts, screws, rivets, clips, and clamps. During assembly of a vehicle fuel cell system (FCS), for example, hose clamps are commonly employed at different stages of the manufacturing process to join various fluid conduits, such as a hydrogen fuel feed hose and a barbed hose connector of a cell stack intake manifold. When installed on the assembly line, it can be difficult for the operator to visually ascertain whether or not the hose clamp was mounted at a part-specific “target” location, secured in a part-specific “target” orientation, and tightened to a part-specific “target” torque that is effective to prevent leakage. Even if adequately tightened during the initial assembly process to prevent leakage, it is possible that the hose clamp was not installed at the correct location or in the correct orientation such that a leak may develop during FCS operation. For automotive applications, metallic screw-band hose clamps are used to connect feed and exhaust hoses to complementary barbed hose connectors. While a direct-current (DC) pneumatic torque wrench (colloquially known as a “nutrunner”) could be used to validate the proper tightening of the screw-band hose clamps, it cannot ensure that the clamp was installed at the part-specced location and in the part-specced orientation.

### SUMMARY

Presented below are automated monitoring systems with attendant control logic for verifying proper installation of fastening devices during part-to-part assembly, methods for manufacturing and methods for operating such systems, and motor vehicles manufactured using such systems. By way of example, and not limitation, an in-line clamp monitoring system and method automates verification of hose clamp installation (“hose clamp error proofing”) in a vehicle assembly plant or vehicle part manufacturing setting. The clamp monitoring system and method combines two interrelated subsystems to error- proof hose clamp installation: (1) an electrical continuity testing device for detecting presence and orientation of the hose clamp; and (2) a precision position-based feedback system for real-time movement and position tracking of the continuity testing device to detect target positioning of the hose clamp. By integrating these two subsystems, the in-line monitoring system/method helps to ensure that a hose clamp was installed at a target location correctly and in a predefined orientation.

Aspects of this disclosure are directed to monitoring system control protocols and processor-executable control logic for error proofing the installation of fastening devices during part-to-part assembly. In an example, a method is presented for operating a clamp monitoring system for verifying installation of a hose clamp on a work part with a hose and a hose connector. This representative method includes, in any order and in any combination with any of the above and below disclosed options and features: receiving, e.g., from an operator or sensor via a resident or remote microcontroller, central processor, control module, programmable logic device, or network of controllers/modules/devices (collectively “system controller”), confirmation that the work part has entered a predefined test envelope within a workstation; outputting, e.g., to the operator or a robot cell via the system controller in response to receiving the entry confirmation, a target (first) command prompt to position a continuity testing device at a predefined target clamp location at which the hose clamp attaches to and seals the work part's hose to its hose connector; outputting, e.g., via the system controller to the operator or robot cell, a trigger (second) command prompt to activate the continuity testing device after the testing device is positioned at the predefined target clamp location; receiving, e.g., via the system controller from the continuity testing device, continuity data indicative of a continuity status at the hose clamp; receiving, e.g., via the system controller from one or more position sensing devices, position data indicative of a real-time device position of the continuity testing device; and outputting, e.g., to an electronic display device and/or a memory-stored fault log via the system controller, a notification that the hose clamp is properly installed on the work part in response to both the continuity status indicating electrical continuity at the hose clamp and the real-time device position aligning with the predefined target clamp location.

Aspects of this disclosure are also directed to computer-readable media (CRM) containing controller-executable instructions for error proofing fastener installation during part-to-part assembly. In an example, a non-transient CRM stores instructions that are executable by one or more processors of a system controller of a clamp monitoring system. The CRM-stored instructions, when executed by the processor(s), cause the system controller to perform operations, including: receiving an entry confirmation indicating a work part entered a predefined test envelope within a workstation; outputting a first command prompt to position a continuity testing device at a predefined target clamp location at which a hose clamp attaches to and seals a hose to a hose connector of the work part; outputting a second command prompt to activate the continuity testing device after being positioned at the predefined target clamp location; receiving, from the continuity testing device, continuity data indicative of a continuity status at the hose clamp; receiving, from a position sensing device, position data indicative of a real-time device position of the continuity testing device; and outputting a notification that the hose clamp is properly installed on the work part in response to the continuity status indicating electrical continuity at the hose clamp and the real-time device position corresponding to the predefined target clamp location.

Additional aspects of this disclosure are directed to smart monitoring systems for error proofing fastener installation during part-to-part assembly, such as the mounting of band clamps onto coolant hoses or fuel hoses of vehicle fuel cell systems. As used herein, the terms “vehicle” and “motor vehicle” may be used interchangeably and synonymously to include any relevant vehicle platform, such as passenger vehicles, commercial vehicles, industrial vehicles, off-road and all-terrain vehicles (ATV), motorcycles, farm equipment, aircraft, watercraft, spacecraft, etc. In an example, a clamp monitoring system includes a robot automated or manually operated electronic continuity testing device that contacts and detects electrical continuity at a hose clamp. The clamp monitoring system employs one or more position sensing devices to track the positioning of the continuity testing device in a predefined test envelope within a workstation.

Continuing with the discussion of the foregoing example, the clamp monitoring system is also equipped with a resident or remote system controller that communicates, wirelessly or by-wire, with the continuity testing device and the position sensing device(s). The system controller is programmed to receive an electronic “entry” confirmation that a work part entered the workstation's test envelope; in response, the controller outputs command prompts to: (1) position the continuity testing device at a predefined target clamp location at which the hose clamp attaches to and seals a hose to a hose connector of the work part; and (2) activate the continuity testing device after being positioned at the target clamp location. Once positioned and activated, the system controller communicates with the continuity testing device to receive therefrom continuity data indicative of a continuity status at the hose clamp. The system controller also communicates with the position sensing device(s) to receive therefrom position data indicative of a real-time position of the continuity testing device. If the continuity status indicates electrical continuity at the hose clamp and the testing device's real-time position aligns with the target clamp location (e.g., within a predefined margin of error), the system controller responsively outputs a notification that the hose clamp is properly installed on the work part.

For any of the disclosed systems, methods, and CRM, the system controller may automate output of an alert that the hose clamp is not properly installed on the work part in response to the continuity status indicating no electrical continuity at the hose clamp (e.g., continuity testing device activated at target clamp location but no continuity detected) and/or the testing device's real-time position not aligning with the target clamp location (e.g., continuity detected but continuity testing device in wrong location). Responsive to the hose clamp not being properly installed, the system controller may output a rework (third) command prompt to the operator/robot cell to loosen and reattach the hose clamp onto the hose at the predefined target clamp location. As another option, the position sensing device may include a networked array of wireless radio receivers that receive wireless radio-frequency (RF) signals from a wireless transceiver mounted onto the continuity testing device to thereby triangulate the testing device's real-time position within the test envelope. Alternatively, the position sensing device may include a networked array of high-resolution cameras; in this instance, the position data may include a time series of images of the continuity testing device within the test envelope.

For any of the disclosed systems, methods, and CRM, the position sensing device(s) may actively track real-time movement of the continuity testing device within the test envelope. As another option, the hose clamp may be a metallic band clamp; in this instance, the continuity status may indicate electrical continuity when the metallic band clamp establishes an electrical path between two electrical leads of the continuity testing device. As a further option, outputting the target (first) command prompt may include the system controller commanding a graphical user interface (GUI) to display the target clamp location and a prompt to position the continuity testing device at the target clamp location to an operator at the workstation. Likewise, outputting the trigger (second) command prompt may include the system controller commanding the GUI to concurrently or separately display a prompt to the workstation operator to manually activate the continuity testing device after being positioned at the target clamp location. For fully automated systems, the system controller may output the target and trigger command prompts to position and activate the continuity testing device to a robotic work cell.

For any of the disclosed systems, methods, and CRM, the system controller may—after to receiving the entry confirmation and prior to transmitting the target and trigger command prompts—output a connect & seal (third) command prompt to the operator/robot to connect the hose with the hose connector and/or secure the hose clamp onto the hose. After outputting the connect & seal command prompt, the system controller may receive an installation confirmation indicating the hose clamp is secured onto the hose. As a further option, the entry confirmation indicating the work part entered the workstation's test envelope may be received via the system controller from a proximity sensor, a limit switch, or a user input device at the workstation. Disclosed concepts may be employed in both vehicular and non-vehicular applications, and may be implemented to error proof installation of assorted fastening devices. Moreover, disclosed hose clamps may take on various suitable form factors, including band clamps, single-wire and multiwire clamps, spring clamps, car clamps, quick-release clamps, buckle clamps, etc.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a perspective-view illustration of a representative motor vehicle with an inset schematic illustration of a vehicular fuel cell system (FCS) with which aspects of this disclosure may be practiced.

FIG. 2 is a perspective-view illustration of a representative clamp monitoring system for error proofing installation of a hose clamp into a fuel cell system of a motor vehicle in accordance with aspects of the present disclosure.

FIG. 3 is a flowchart illustrating a representative manufacturing control protocol for error proofing hose clamp installation into a motor vehicle, which may correspond to memory-stored instructions that are executable by a resident or remote microcontroller, control module, logic circuit, or other integrated circuit (IC) device or network of circuits/modules/microcontrollers/IC devices (collectively “controller”) in accordance with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

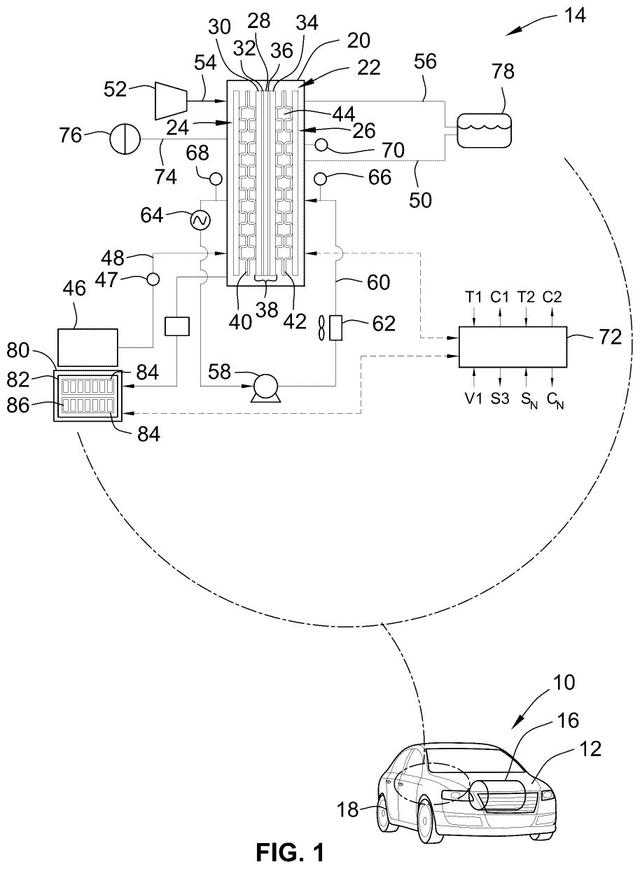

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into the illustrated clamp monitoring system for error-proofing hose clamp installation should be appreciated as a non-limiting implementation of disclosed features. As such, it will be understood that novel features of this disclosure may be implemented by other monitoring system architectures to error proof installation of assorted fastening devices, may be incorporated into any logically relevant type of motor vehicle, and may be employed for both automotive and non-automotive applications alike. Moreover, only select components of the motor vehicle and clamp monitoring system are shown and described in detail herein. Nevertheless, the vehicles and systems discussed below may include numerous additional and alternative features, and other available peripheral hardware, for carrying out the various methods and functions of this disclosure.

Packaged within the vehicle body 12 of automobile 10 of FIG. 1 is a fuel cell system (FCS) 14 for powering a prime mover, such as an electric motor generator unit (MGU) 16, that is operable to drive one or more of the vehicle's road wheels 18 to thereby propel the vehicle 10. Fuel cell system 14 of FIG. 1 is equipped with one or more fuel cell stacks 20, each of which may be composed of proton exchange membrane (PEM) fuel cells 22 that are stacked and electrically connected with one another. Each fuel cell 22 is a multi-layer construction with an anode side 24 and a cathode side 26 that may be separated by a proton-conductive perfluorosulfonic acid membrane 28. An anode diffusion media layer 30 is located on the anode side 24 of the PEMFC 22, with an anode catalyst layer 32 interposed between and operatively connecting the membrane 28 and corresponding diffusion media layer 30. Juxtaposed with the anode layers 30 and 32 is a cathode diffusion media layer 34 that is provided on the cathode side 26 of the PEMFC 22. A cathode catalyst layer 36 is interposed between and operatively connects the membrane 28 and corresponding diffusion media layer 34. The two catalyst layers 32 and 36 cooperate with the membrane 28 to at least partially define a membrane electrode assembly (MEA) 38. The diffusion media layers 30 and 34 are porous constructions that provide for fluid inlet transport to and fluid exhaust transport from the MEA 38.

An anode flow field plate (or “first plate”) 40 is located on the anode side 24 in abutting relation to the anode diffusion media layer 30. Likewise, a cathode flow field plate (or “second plate”) 42 is located on the cathode side 26 in abutting relation to the cathode diffusion media layer 34. Coolant flow channels 44 traverse each of the plates 40 and 42 to allow cooling fluid to flow through the fuel cell 22. Fluid inlet ports and headers direct a hydrogen-rich fuel and an oxidizing agent to respective passages in the anode and cathode flow field plates 40, 42. A central active region of the anode's plate 40 that faces the proton-conductive membrane 28 may be fabricated with an anode flow field composed of serpentine flow channels for distributing hydrogen over an opposing face of the membrane 28. The MEA 38 and plates 40, 42 may be stacked together between stainless steel clamping plates and monopolar end plates (not shown). These clamping plates may be electrically insulated from the end plates by a gasket or dielectric coating.

Hydrogen (H₂) inlet flow—be it gaseous, concentrated, entrained, or otherwise—is transmitted from a hydrogen source, such as fuel storage tank 46, to the anode side 24 of the fuel cell stack 20 via a fluid injector 47 coupled to a (first) fluid intake conduit or hose 48. Anode exhaust exits the stack 20 via a (first) fluid exhaust conduit or hose 50. Although shown on the anode side of the stack, a compressor or pump 52 forces a cathode inlet flow, such as ambient air and/or concentrated gaseous oxygen (O₂), via a (second) fluid intake line or manifold 54 to the cathode side 26 of the stack 20. Cathode exhaust is output from the stack 20 via a (second) fluid exhaust conduit or hose 56. Electricity generated by the fuel cells 22 and output by the fuel cell system 14 may be stored by an in-vehicle traction battery pack 82 within a rechargeable energy storage system (RESS) 80.

Fuel cell system 14 of FIG. 1 may also include a thermal sub-system operable for controlling the temperature of the fuel cell stack 20 during preconditioning, break-in, post-conditioning, etc. A coolant pump 58 pumps a cooling fluid through a coolant loop 60 to the fuel cell stack 20 and into the coolant channels 44 in each cell 22. A radiator 62 and an optional heater 64 may be fluidly coupled in the coolant loop 60 to maintain the stack 20 at a desired operating temperature. A (first) temperature sensor 66 may monitor a temperature value of the coolant at a coolant inlet to the fuel cell stack 20, and a (second) temperature sensor 68 may measure a temperature value of the coolant at a coolant outlet of the stack 20. An electrical connector or cable 74 connects the fuel cell stack 20 to an electric power load 76, which may be employed to draw current from each cell 22 in the stack 20. A voltage/current sensor 70 is operable to measure fuel cell voltage and/or current across the fuel cells 22 in the stack 20.

A programmable electronic control unit (ECU) 72 helps to control operation of the fuel cell system 14. As an example, the ECU 72 may receive temperature signals T1 from the temperature sensors 66, 68 that indicate the operating temperature of the fuel cell stack 20, and may responsively issue command signals C1 to modulate operation of the stack 20. ECU 72 may also receive voltage signals V1 from the voltage/current sensor 70, and may responsively issue command signals C2 to modulate operation of a hydrogen storage tank 46 and/or compressor/pump 52 to thereby regulate the electrical output of the stack 20. ECU 72 of FIG. 1 may also receive coolant temperature signals T2 from the temperature sensors 66, 68, and responsively issue command signals S3 to modulate operation of the fuel cell's thermal system. Additional sensor signals S_{N} may be received by, and additional control commands C_{N} may be issued from the ECU 72 to control any other sub-system or component described herein. The ECU 72 may emit a command signal to transmit evolved hydrogen and liquid H₂O from the cathode side 26, through exhaust conduit 56, and to a storage tank 78 (FIG. 1) where hydrogen and water may be combined with depleted hydrogen exhausted from the anode through fluid exhaust conduit/hose 50.

The traction battery pack 82 of FIG. 1 may contain an array of rechargeable lithium-class (secondary) battery modules 84. Disclosed concepts are similarly applicable to other electric storage form factors, including nickel metal hydride (NiMH) batteries, solid-state (SS) batteries, lithium-metal and lithium-sulfur batteries, and other applicable type of rechargeable electric vehicle battery (EVB). Each battery module 84 may include a cluster of electrochemical battery cells, such as prismatic, cylindrical, or pouch-type lithium ion (Li-ion) or Li-ion polymer battery cells 86. To boost the voltage output of the vehicle FCS, a respective DC-to-DC boost converter (DC CON) may be electrically interposed between the fuel cell stack 20 and the RESS 80.

To ensure uninterrupted and efficient operation of the fuel cell system 14, it is vital that all fluid-transporting conduits be securely attached and sealed to their respective fluid ports to maintain consistent, uncorrupted fluid flow. For instance, great care should be taken when installing FCS fuel and coolant feed lines to obviate a high-severity system failure, such as coolant system leaks resulting in reduced coolant flow or ionized coolant fluid. Original equipment manufacturers (OEM) may therefore implement additional “failsafe” measures during the assembly process to ensure that hose and hose clamp installation is completed according to specific engineered standards (“to spec”). Many FCS architectures employ screw-band (worm gear) hose clamps to attach and seal FCS coolant/fuel hoses to male barbed hose connectors, which allows the clamp-installing operator to record a torque value as a manner of proving the clamp and hose were installed. This procedure, however, may not ensure that the hose clamp was properly installed since the clamp may have been improperly placed on top of the connector barb or, worse, may be mounted off of the hose fitting. To “error proof” spring-type hose clamp installation may necessitate verifying the hose clamp was mounted at a part-specific “target” location and secured in a part-specific “target” orientation.

Discussed below are automated monitoring systems with attendant processor-executable control logic for verifying the proper installation of fastening devices during part-to-part assembly. By way of example, and not limitation, an in-line clamp monitoring system and method automates hose clamp error proofing in a vehicle assembly plant using precision position recognition and continuity analysis. Precision position recognition may be accomplished in multiple ways, including: (1) vision-based systems using a networked array of stationary stereo cameras to triangulate tool location and orientation; (2) radial, linear, and axial sensors to track end effector position and orientation of an articulating robot arm; and (3) tool-mounted RF tethers for real-time tracking of tool location and orientation. Continuity analysis may be achieved by applying a metered current between two electrical test probes to measure resistance, e.g., to confirm the probes are a touching metallic clamp and not a polymeric hose. In a representative configuration, a robotic work cell includes a controller-automated articulating robot arm with an end effector bearing the continuity test probes, and an array of position recognition sensors to track real-time or near-real-time position and orientation of the end effector. The probes may be spaced about 5 to 10 millimeters (mm) apart and may be spring loaded to accommodate differing geometries of hose clamps. Part-spec'd target positions of one or more hose clamps may be programmed by the manufacturing team for each FCS assembly.

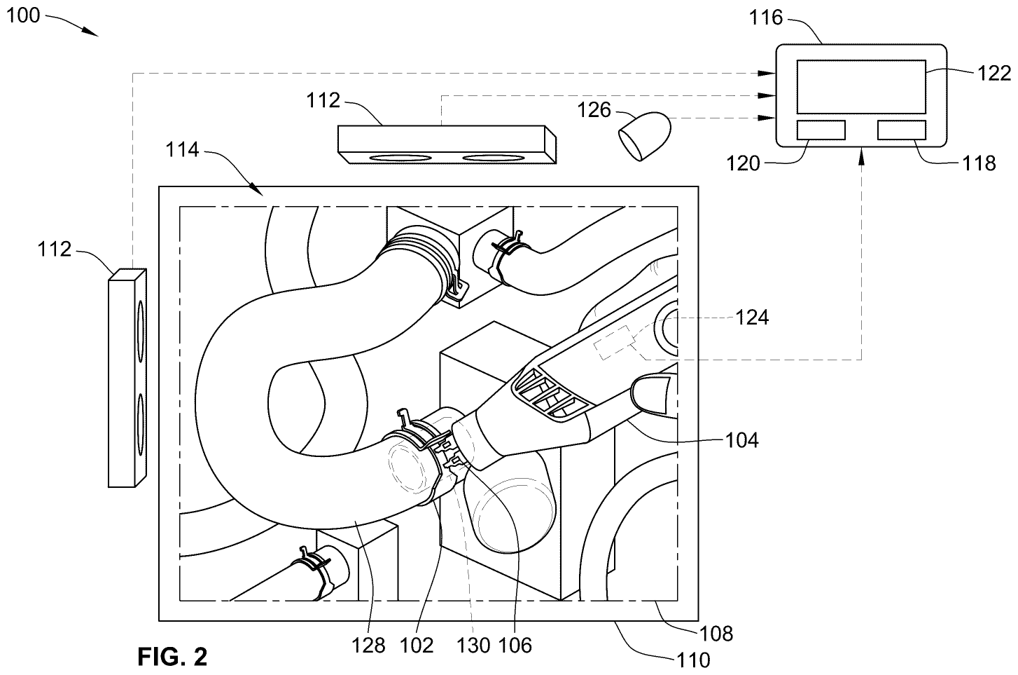

Turning next to FIG. 2, there is shown an example of a clamp monitoring system 100 for error proofing installation of a metallic spring-type hose clamp 102 into a fuel cell system 114, such as vehicle FCS 14 of FIG. 1. In accord with the illustrated example, the clamp monitoring system 100 employs a manually operated electronic continuity testing device 104 with a pair of electrical test leads 106 that are designed to physically contact and concomitantly pass an electric current through the hose clamp 102 to detect electrical continuity across the clamp 102. As noted above, the hose clamp 102 may be a metallic spring-type band clamp, e.g., to eliminate the need for validating the proper tightening of a screw-band hose clamp. The continuity testing device 104 may detect electrical continuity at the hose clamp 102 when the clamp's metallic band establishes an electrical path (i.e., completes an electrical circuit) between the two test leads 106. For case of use and freedom of movement, it may be desirable that the continuity testing device 104 be a wireless-enabled and battery-powered handheld device. It is also envisioned that the continuity testing device 104 may be integrated into a robot end effector of a floor, counter, or gantry mounted robot assembly for fully automated system architectures.

The clamp monitoring system 100 of FIG. 2 also utilizes a precision position recognition subsystem to actively track real-time or near-real-time positioning of the continuity testing device 104 inside a predefined test envelope 108 inset within an operator workstation 110, such as a line-side workstation module in a vehicle assembly plant. While not per se limited, the position sensing subsystem may be typified by a networked array of position sensing devices 112 that generate position data indicative of the continuity testing device's real-time position and, if desirable, real-time movement and orientation. For at least some applications, each sensing devices 112 may be a wireless radio-frequency (RF) receiver/transceiver that receives wireless RF signals from and, optionally, transmits RF signals to a wireless RF transmitter/transceiver tether 124 that is mounted on or inside the continuity testing device 104. Using the wireless signals received by the RF receiver/transceiver sensing devices 112 from the tool-mounted tether 124, a central system controller 118 of a workstation operator interface unit 116 triangulates the real-time device position of the continuity testing device 104. Alternatively, the position recognition subsystem may be a vision-based system in which the position sensing devices 112 are a networked array of high-resolution cameras that may continually track movement of the continuity testing device 104. In this instance, the position data output by the high-resolution camera sensing devices 112 may include a time series of images of the continuity testing device 104 within the test envelope 108; these images may be preprocessed, filtered, and fused to derive the real-time device position of the continuity testing device 104.

With continuing reference to FIG. 2, the workstation operator interface unit 116 may be a line-side mobile computing device that provides a mixture of services, both individually and through its communication with other networked devices. This interface unit 116 may be generally composed of one or more processors, each of which may be embodied as a discrete microprocessor, an application specific integrated circuit (ASIC), or a dedicated control module. Clamp monitoring system 100 may offer centralized system control via a central system controller 118 that is operatively coupled to a touchscreen display device 122 and one or more electronic memory devices 120, each of which may take on the form of a CD-ROM, magnetic disk, IC device, a solid-state drive (SSD) memory, a hard-disk drive (HDD) memory, flash memory, semiconductor memory (e.g., various types of RAM or ROM), etc. The central system controller 118 of workstation operator interface unit 116 may receive confirmation that the FCS 114 work part has entered the test envelope 108 of workstation 110 from a proximity sensor or a limit switch (collectively designated 126 in FIG. 2) or from the operator via touchscreen display device 122 or other suitable user input device.

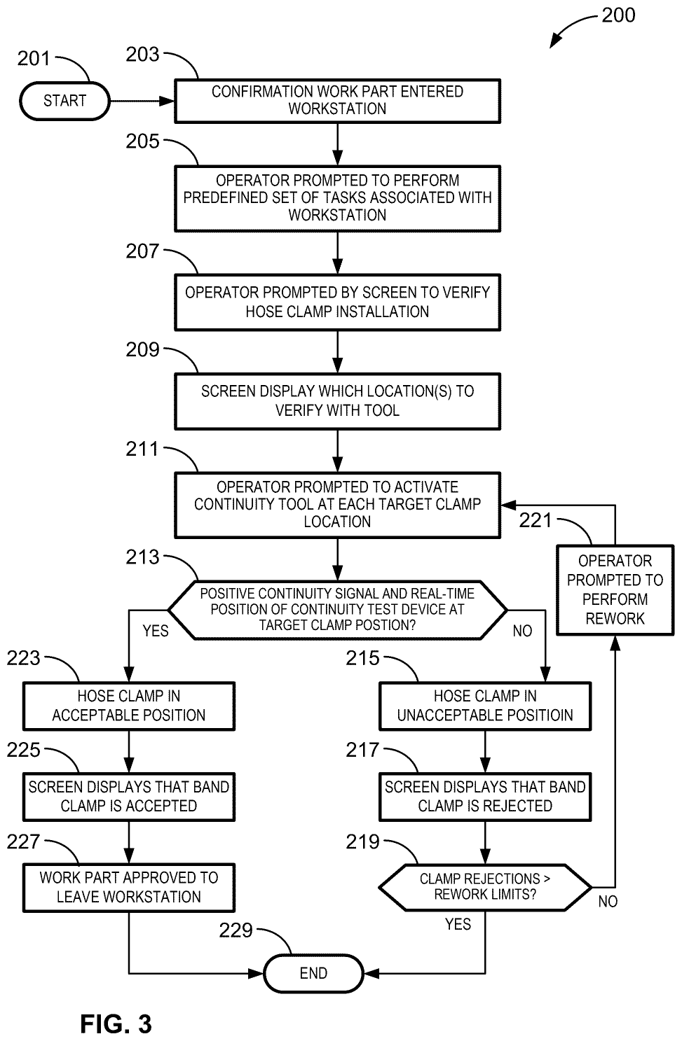

With reference next to the flow chart of FIG. 3, an improved method or control protocol for error proofing installation of a fastening device, such as hose clamp 102 of FIG. 2, onto a work part, such as fuel cell systems 14 and 114 of FIGS. 1 and 2, is generally described at 200 in accordance with aspects of the present disclosure. Some or all of the operations illustrated in FIG. 3 and described in further detail below may be representative of an algorithm that corresponds to non-transitory, processor-executable instructions that are stored, for example, in main or auxiliary or remote memory (e.g., resident memory device(s) 120 of FIG. 2). These instructions may be executed, for example, by an electronic controller, processing unit, dedicated control module, logic circuit, or other module or device or network of controllers/modules/devices (e.g., central system controller 118 of FIG. 2), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 begins at START terminal block 201 of FIG. 3 with memory-stored, processor-executable instructions for initializing a part-to-part assembly procedure with an integrated fastener installation error proofing control protocol. This routine may be initialized in real-time, near real-time, continuously, systematically, sporadically, and/or at predefined time intervals, for example, each 10 or 100 milliseconds during use of the operator workstation 110. As yet another option, terminal block 201 may initialize responsive to a user command prompt (e.g., input via telematics input controls), a resident workstation controller prompt (e.g., output by central system controller 118), or a broadcast prompt signal received from a centralized back-office (BO) plant server center. Upon completion of some or all of the control operations presented in FIG. 3, method 200 may advance to END terminal block 229 and temporarily terminate or, optionally, may loop back to terminal block 201 and run in a continuous loop.

Advancing from terminal block 201 to ENTRY CONFIRMATION data input block 203, method 200 verifies a work part has entered a predefined test envelope within a workstation. As noted above in the discussion of FIG. 2, a proximity sensor or limit switch 126 may detect entry of the fuel cell system 114 into the workstation test envelope 108 and output sensor data indicative thereof to the central system controller 118. Alternatively, a workstation operator may confirm entry of the fuel cell system 114 by selecting a virtual radio or binary button on the touchscreen display device 122. Entry confirmation may also necessitate verifying that the received work part is both (1) a correct part type and (2) is set in a “zeroed” target part orientation within the test envelope 108.

Upon receipt of a work part, the workstation operator may be prompted to complete a predefined task or set of tasks associated with that particular workstation, as indicated at WORKSTATION TASKS display block 205. For instance, the central system controller 118 may respond to receipt of an electronic entry confirmation indicating the FCS 114 entered the test envelope 108 by commanding the touchscreen display device 122 to display a prompt or series of prompts to the workstation operator to: first, loosely position the hose clamp 102 around an intermediate segment of a male barded hose connector 130 of the FCS 114; second, press-fit an open terminal end of a coolant feed hose 128 onto a barbed open end of the hose connector 130; and, third, secure the hose clamp 102 onto the coolant feed hose 128 in a part-spec'd “target” location and a part-spec'd “target” orientation. Once the displayed connect & seal tasks are completed, the central system controller 118 may receive a user-input confirmation indicating the requested task or tasks have been accomplished, as indicated at TASK COMPLETION display block 207. It is envisioned that process blocks 205 and 207 may be omitted, in whole or in part, from method 200, e.g., in scenarios in which the FCS 114 is received at the workstation 110 with the hose 128 and/or hose clamp 102 already installed.

After receiving a work part (block 203) and confirming a hose clamp has been installed on the work part (block 207), method 200 may responsively execute TARGET LOCATION subroutine 209 of FIG. 3 to position a continuity testing device at a predefined target clamp location at which a designated hose clamp attaches to and seals a corresponding hose to its respective hose connector of a subject work part. For fully automated systems, the central system controller 118 may issue a sequence of target control commands to a robot cell's primary control module or directly to a set of servo motors that govern movement of a robot arm to move an end effector-integrated continuity testing device to a part-spec'd target position within a 3D space of the testing envelope. For manual applications, the central system controller 118 may command the graphical user interface (GUI) of the touchscreen display device 122 to display the predefined target clamp location or locations being tested, and concomitantly display a prompt to move the continuity testing device to each displayed target location.

In tandem with TARGET LOCATION subroutine 209, method 200 may execute TOOL ACTIVATION subroutine 211 to activate the continuity testing device at each of the predefined target clamp location. For fully automated systems, the central system controller 118 may issue a trigger control command to a robot cell's primary control module or directly to the end effector-integrated continuity testing device to activate the device at each part-spec'd target position. For manual applications, the central system controller 118 may command the graphical user interface (GUI) of the touchscreen display device 122 to display—concurrently with or separately from the target control commands—a prompt to the operator at the workstation to activate the continuity testing device 104 at each target location.

Method 200 of FIG. 3 advances from TOOL ACTIVATION subroutine 211 to FAULTY INSTALL decision block 213 to determine whether or not each hose clamp is properly installed on the work part. As noted above, the clamp monitoring system 100 may implement a two part approach for error-proofing hose clamp installation, namely precision position recognition in conjunction with electrical continuity analysis. As per the former, the central system controller 118 may communicate with one or more position sensing devices, such as the networked array of position sensing devices 112 of FIG. 2, to receive therefrom position data indicative of a real-time device position of the continuity testing device 104. For at least some applications, it may be desirable to actively track real-time movement, positioning, and orientation of the continuity testing device 104, including detecting arrival of the continuity testing device 104 at each target location. At the same time, the central system controller 118 of FIG. 2 may communicate with the continuity testing device 104 to receive therefrom continuity data that is indicative of a continuity status at the hose clamp 102 (e.g., a binary YES/NO reading or a resistance reading of zero (0) Ohms or open line (OL)).

Decision block 213 will return a negative or IMPROPER INSTALL result if either or both: (1) the continuity status output by the continuity testing device 104 indicates no electrical continuity at the hose clamp, and (2) the real-time position of the continuity testing device 104, when activated, does not substantially align with the predefined target clamp location for that hose clamp. If a tested hose clamp is not properly installed (Block 213=NO), method 200 of FIG. 3 may responsively execute FAULT FLAG data storage block 215 and set a fault flag in resident memory device(s) 120 noting that the tested hose clamp is either not detected or is in an unacceptable position. In tandem with setting a memory-stored fault flag, the method 200 may responsively execute FAULTY CLAMP display block 217 and output a visual, audible, and/or haptic alert, e.g., via continuity testing device 104 and/or workstation operator interface unit 116, that the tested hose clamp is not properly installed on the work part.

After outputting an alert that the hose clamp is not properly installed, method 200 of FIG. 3 may execute TIMEOUT loop exit 219 and determine whether or not a total number of IMPROPER INSTALL clamp rejections for a given hose clamp exceeds a maximum allowable number of clamp reworks. For example, a workstation operator may be given three (3) opportunities to attempt to rework and fix an improperly installed hose clamp; if that clamp is rejected a fourth time, the method 200 may timeout. If the total number of clamp rejections for the subject hose clamp exceeds the maximum allowable number of clamp reworks (Block 219=YES), method 200 may exit the FAULTY INSTALL loop and temporarily terminate at terminal block 229. If not (Block 219=NO), method 200 may execute CLAMP REWORK subroutine 221 and attempt to correct the improperly installed hose clamp. For instance, the central system controller 118 of FIG. 2 may respond to the hose clamp 102 not being properly installed on the FCS 114 by commanding the touchscreen display device 122 to prompt the workstation operator to loosen the hose clamp 102, reposition the hose clamp 102 on the coolant feed hose 128 and hose connector 130, and reattach the hose clamp 102 onto the hose 128 at the predefined target clamp location. For fully automated systems, the foregoing assembly processes may be executed by the articulating robot arm and robot end effector of the robotic work cell. Once the hose clamp is reworked, method 200 will loop back through TOOL ACTIVATION subroutine 211 and FAULTY INSTALL decision block 213.

Decision block 213 will return a positive or PROPER INSTALL result if both: (1) the continuity status output by the continuity testing device 104 indicates electrical continuity at the tested hose clamp, and (2) the real-time position of the continuity testing device 104, when activated, substantially aligns (e.g., within acceptable manufacturing tolerances) with the predefined target clamp location for that hose clamp. If a tested hose clamp is properly installed (Block 213=YES), method 200 of FIG. 3 may responsively execute PASS FLAG data storage block 223 and set a pass flag in resident memory device(s) 120 noting that the tested hose clamp was detected and is in an unacceptable position. In tandem with setting a memory-stored pass flag, the method 200 may responsively execute ACCEPTED CLAMP display block 225 and output a visual, audible, and/or haptic alert, e.g., via continuity testing device 104 and/or workstation operator interface unit 116, that the tested hose clamp is properly installed on the work part. At this juncture, method 200 may execute PART RELEASE data output block 227 and alert the workstation operator or robotic work cell that the work part is approved to leave the workstation. Method 200 may thereafter temporarily terminate at terminal block 229.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a clamp monitoring system for verifying installation of a hose clamp on a work part with a hose and a hose connector, the method comprising:
receiving, via a system controller of the clamp monitoring system, an entry confirmation indicating the work part entered a predefined test envelope within a workstation;
outputting, via the system controller in response to receiving the entry confirmation, a first command prompt to position a continuity testing device at a predefined target clamp location at which the hose clamp attaches to and seals the hose to the hose connector of the work part;
outputting, via the system controller, a second command prompt to activate the continuity testing device after being positioned at the predefined target clamp location;
receiving, via the system controller from the continuity testing device, continuity data indicative of a continuity status at the hose clamp;
receiving, via the system controller from a position sensing device, position data indicative of a real-time device position of the continuity testing device; and
outputting, via the system controller, a notification that the hose clamp is properly installed on the work part in response to the continuity status indicating electrical continuity at the hose clamp and the real-time device position aligning with the predefined target clamp location.

2. The method of claim 1, further comprising outputting, via the system controller, an alert that the hose clamp is not properly installed on the work part in response to the continuity status indicating no electrical continuity at the hose clamp and/or the real-time device position not aligning with the predefined target clamp location.

3. The method of claim 2, further comprising outputting, via the system controller in response to the hose clamp not being properly installed on the work part, a third command prompt to loosen and reattach the hose clamp onto the hose at the predefined target clamp location.

4. The method of claim 1, wherein the position sensing device includes a networked array of wireless radio receivers configured to receive wireless radio-frequency signals from a wireless transceiver of the continuity testing device to thereby triangulate the real-time device position of the continuity testing device.

5. The method of claim 1, wherein the position sensing device includes a networked array of high-resolution cameras, and the position data includes a time series of images of the continuity testing device within the test envelope.

6. The method of claim 1, further comprising tracking, via the position sensing device, real-time movement of the continuity testing device within the test envelope.

7. The method of claim 1, wherein the hose clamp includes a metallic band clamp, and wherein the continuity status indicates electrical continuity at the hose clamp when the metallic band clamp establishes an electrical path between two leads of the continuity testing device.

8. The method of claim 1, wherein outputting the first command prompt includes the system controller commanding a graphical user interface to display, to an operator at the workstation, the predefined target clamp location and a prompt to position the continuity testing device.

9. The method of claim 8, wherein outputting the second command prompt includes the system controller commanding the graphical user interface to concurrently or separately display a prompt to the operator at the workstation to activate the continuity testing device.

10. The method of claim 1, wherein the system controller outputs the first and second command prompts to position and activate the continuity testing device to a robotic work cell.

11. The method of claim 1, further comprising outputting, via the system controller in response to receiving the entry confirmation and prior to transmitting the first and second command prompts, a third command prompt to connect the hose with the hose connector and/or secure the hose clamp onto the hose.

12. The method of claim 11, further comprising receiving, via the system controller, an installation confirmation indicating the hose clamp is secured onto the hose.

13. The method of claim 1, wherein the entry confirmation is received via the system controller from a proximity sensor, a limit switch, or a user input device at the workstation.

14. A non-transient, computer-readable medium storing instructions executable by a system controller of a clamp monitoring system for verifying installation of a hose clamp on a work part with a hose and a hose connector, the instructions, when executed, causing the system controller to perform operations comprising:
receiving an entry confirmation indicating the work part entered a predefined test envelope within a workstation;
outputting a first command prompt to position a continuity testing device at a predefined target clamp location at which the hose clamp attaches to and seals the hose to the hose connector of the work part;
outputting a second command prompt to activate the continuity testing device after being positioned at the predefined target clamp location;
receiving, from the continuity testing device, continuity data indicative of a continuity status at the hose clamp;
receiving, from a position sensing device, position data indicative of a real-time device position of the continuity testing device; and
outputting a notification that the hose clamp is properly installed on the work part in response to the continuity status indicating electrical continuity at the hose clamp and the real-time device position corresponding to the predefined target clamp location.

15. A clamp monitoring system for verifying installation of a hose clamp on a work part with a hose and a hose connector, the clamp monitoring system comprising:
a continuity testing device configured to contact and detect electrical continuity at the hose clamp;
a position sensing device configured to detect a position of the continuity testing device in a predefined test envelope within a workstation; and
a system controller communicatively connected to the continuity testing device and the position sensing device, the system controller being programmed to:
receive an entry confirmation indicating the work part entered the predefined test envelope within the workstation;
in response to receiving the entry confirmation, output a first command prompt to position the continuity testing device at a predefined target clamp location at which the hose clamp attaches to and seals the hose to the hose connector;
output a second command prompt to activate the continuity testing device after being positioned at the predefined target clamp location;
receive, from the continuity testing device, continuity data indicative of a continuity status at the hose clamp;
receive, from the position sensing device, position data indicative of a real-time device position of the continuity testing device; and
output a notification that the hose clamp is properly installed on the work part in response to the continuity status indicating electrical continuity at the hose clamp and the real-time device position aligning with the predefined target clamp location.

16. The clamp monitoring system of claim 15, wherein the system controller is further programmed to output an alert that the hose clamp is not properly installed on the work part in response to the continuity status indicating no electrical continuity at the hose clamp and/or the real-time device position not aligning with the predefined target clamp location.

17. The clamp monitoring system of claim 15, wherein the system controller is further programmed to output, in response to the hose clamp not being properly installed on the work part, a third command prompt to an operator at the workstation to reattach the hose clamp onto the hose at the predefined target clamp location.

18. The clamp monitoring system of claim 15, wherein the hose clamp includes a metallic band clamp, and wherein the continuity status indicates electrical continuity at the hose clamp when the metallic band clamp establishes an electrical path between two leads of the continuity testing device.

19. The clamp monitoring system of claim 15, wherein outputting the first command prompt includes the system controller commanding a graphical user interface to display, to an operator at the workstation, the predefined target clamp location and a prompt to position the continuity testing device.

20. The clamp monitoring system of claim 15, wherein the system controller is further programmed to output, in response to receiving the entry confirmation, a third command prompt to connect the hose with the hose connector and/or secure the hose clamp onto the hose.
